(19) United States
(12) Patent Application Publication
(10) Pub. No.: US 2019/0187502 A1
(43) Pub. Date: Jun. 20, 2019

(54) DISPLAY SUBSTRATE, PRODUCTION METHOD FOR DISPLAY SUBSTRATE, AND DISPLAY PANEL

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Fangzhuan Liu, Beijing (CN); Jingyu Wang, Beijing (CN); Jungho Park, Beijing (CN)

(21) Appl. No.: 16/328,634

(22) PCT Filed: Mar. 13, 2018
(86) PCT No.: PCT/CN2018/078830

§ 371 Date: Feb. 26, 2019

(30) Foreign Application Priority Data
May 5, 2017 (CN) 201710311899.2

(51) Int. Cl. G02F 1/1339; G02F 1/1335; G02F 1/1343; G02F 1/1337

(52) U.S. Cl. CPC G02F 1/13394; G02F 1/133514; G02F 1/1368; G02F 1/134309; G02F 1/1337; G02F 1/133512

(57) ABSTRACT

This disclosure discloses a display substrate, a production method for a display substrate, and a display panel. The display substrate comprises a display area and a preset seal area surrounding the display area, wherein the display area is provided with a plurality of spacers, and wherein the preset seal area is provided with a plurality of supports, the support and the spacer are provided in the same layer and are of the same material.

### CROSS-REFERENCE TO RELATED APPLICATION

This disclosure claims the priority of Chinese Patent Application No. 201710311899.2 filed on May 5, 2017, which is incorporated herein in its entirety by reference.

### TECHNICAL FIELD

This disclosure relates to the technical field of display, and specifically to a display substrate, a production method for a display substrate, and a display panel comprising this display substrate.

### BACKGROUND ART

Generally, a seal is required to be applied around a thin-film transistor display panel for the purpose of connecting a color filter substrate and an array substrate, and this is capable of effectively prevent leakage of liquid crystal which occurs between the array substrate and the color filter substrate. In a seal area, a filler such as silicon balls and the like is filled in addition to the seal so as to maintain the cell thickness at the periphery of the display panel.

### SUMMARY

This disclosure proposes a display substrate, a production method for a display substrate, and a display panel comprising this display substrate.

In order to achieve the object described above, a first aspect of this disclosure provides a display substrate, comprising

a display area, and

a preset seal area surrounding the display area,

wherein the display area is provided with a plurality of spacers, and wherein the preset seal area is provided with a plurality of supports, the support comprises a supporting core, and the supporting core and the spacer are provided in the same layer and are of the same material.

Optionally, the plurality of supports are evenly distributed in the preset seal area.

Optionally, the support has a thickness greater than that of the spacer.

Optionally, the display substrate is a color filter substrate.

Optionally, the color filter substrate comprises a color filter layer, a black matrix, and a protective layer, the protective layer covers the color filter layer and the black matrix, and the support is provided on the protective layer.

Optionally, the color filter substrate comprises a common electrode, the support further comprises a conductive layer coating the supporting core, and the conductive layer is electrically connected to the common electrode.

Optionally, the display substrate is an array substrate.

Optionally, the array substrate comprises a common electrode, the support further comprises a conductive layer coating the supporting core, and the conductive layer is electrically connected to the common electrode.

As a second aspect of this disclosure, there is provided a display panel, comprising the display substrate according to any one described above and a cell alignment substrate aligned with the display substrate to form a cell, wherein at the preset seal area, the display substrate and the cell alignment substrate are bonded to each other by filling a seal therebetween.

Optionally, at the display area, a liquid crystal is filled between the display substrate and the cell alignment substrate.

Optionally, each of the display substrate and the cell alignment substrate has a common electrode, the support comprises a conductive layer coating on the outside of the supporting core, and the conductive layer allows electrical conduction between the common electrodes.

As a third aspect of this disclosure, there is provided a production method for a display substrate, wherein the display substrate comprises a display area and a preset seal area surrounding the display area, and the production method comprises:

forming a plurality of spacers and a plurality of supporting cores by using a single patterning process, wherein the plurality of the spacers are located in the display area of the display substrate, and the plurality of the supporting cores are located in the preset seal area of the display substrate.

Optionally, the production method further comprises:

forming a conductive layer coating the supporting core on an outer layer of the supporting core.

Optionally, the single patterning process is performed by exposing a photoresist layer with a half-tone mask plate and developing and etching the photoresist layer.

Optionally, the photoresist layer is a positive photoresist layer, and the half-tone mask plate has a light-shielding area corresponding to a position where the support is to be formed, a semitransparent area corresponding to a position where the spacer is to be formed, and a light-transmitting area corresponding to other areas.

Optionally, the photoresist layer is a negative photoresist layer, and the half-tone mask plate has a light-transmitting area corresponding to a position where the support is to be formed, a semitransparent area corresponding to a position where the spacer is to be formed, and a light-shielding area corresponding to other areas.

### DESCRIPTION OF DRAWINGS

The accompanying drawings are intended to provide further understanding of this disclosure, and constitute a part of the specification and are used for explaining this disclosure together with specific embodiments below. However, they do not constitute the limitation of this disclosure. In the drawing:

FIG. 1 is a schematic diagram showing a seal area of a display panel in the related art;

FIG. 2 is a schematic diagram of a seal area of a display panel in an embodiment of this disclosure;

FIG. 3 is a schematic diagram of a section of a display panel in an embodiment of this disclosure;

FIG. 4 is a schematic diagram of a section of a display panel in another embodiment of this disclosure;

### DESCRIPTION OF EMBODIMENTS

Specific embodiments of this disclosure are illustrated in detail below in conjunction with the accompanying drawing. It is to be understood that specific embodiments described hereby are provided to illustrate and explain this disclosure only, but are not intended to limit this disclosure.

Reference numerals in the figures represent the following components, respectively: 100: array substrate; 100′: color filter substrate; 110: black matrix; 120: color filter layer; 130: protective layer; 140, 240: alignment layer; 150: support; 151: conductive layer; 152: supporting core; 160: spacer; 180: common electrode wire; 200: display panel; 211: pixel electrode; 212: insulating layer; 213: common electrode; 214: data wire; 215: gate insulating layer; 216: gate electrode; 220: seal; 230: silicon ball; A: display area; B: preset seal area.

FIG. 1 illustrates a display panel in the related art, such as a display panel. In order to maintain the cell thickness at the periphery of the display panel, silicon balls (Si balls) 230 are usually filled in a seal 220, and the volume ratio of the seal 220 to the silicon balls 230 is typically 100:1.

However, in the case where the silicon balls 230 are filled, the phenomenon of uneven mixing of the seal 220 and the silicon balls 230 will easily occur, and it will lead to uneven cell thickness at the periphery of the display panel. At the same time, the production costs and the procedures of the display panel are further increased. Furthermore, when the cell thickness at the periphery is maintained by the silicon balls 230, the supporting strength at the periphery of the display panel cannot be ensured.

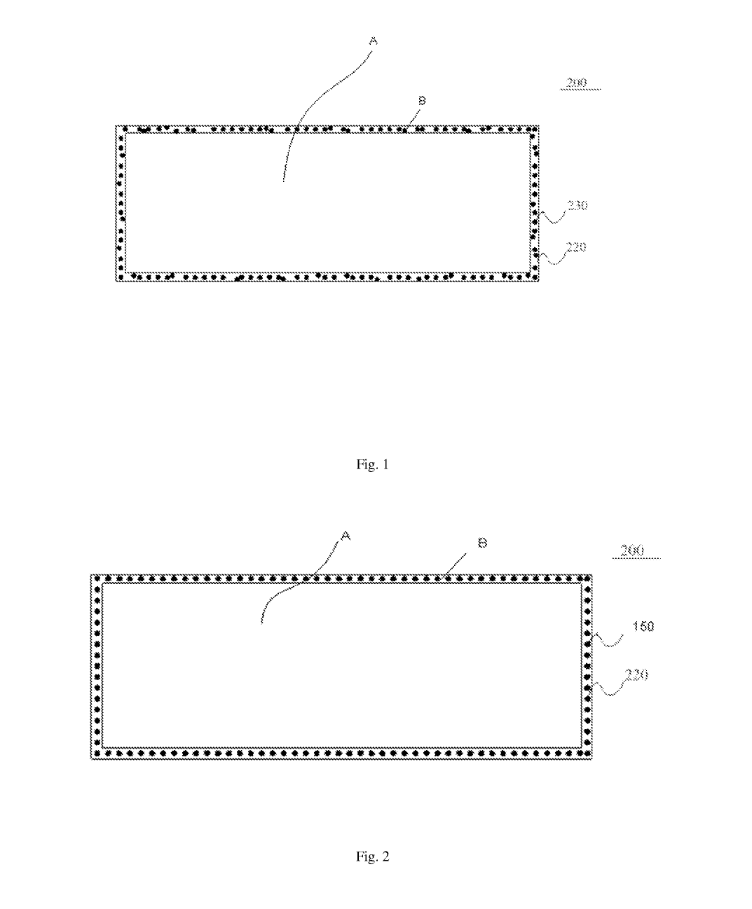

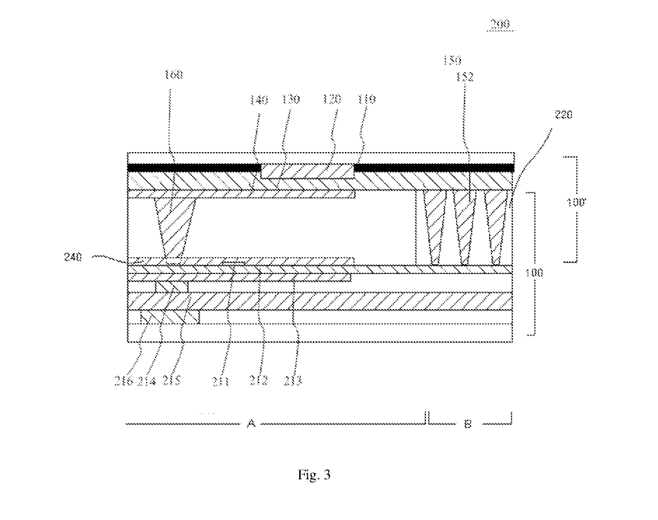

With reference to FIG. 2 and FIG. 3, a first aspect of this disclosure relates to a display substrate. This display substrate comprises a display area A for image display and a preset seal area B surrounding this display area. Here, a plurality of supports 150 are provided in the preset seal area B and this support 150 comprises a supporting core 152, a plurality of spacers 160 (the one closest to the seal area is shown in the figures) are provided in the display area A, and the supporting core 152 and the spacer 160 are provided in the same layer and are of the same material.

It is to be indicated that the specific type of this display substrate is not limited. For example, this display substrate may be an array substrate 100, or may be a color filter substrate 100′ aligned with the array substrate to form a cell. The supports in preset seal area B and the spacers in the display area A may be produced in the array substrate 100 or may be produced in the color filter substrate 100′. It is to be understood that when a support and a spacer have been produced in one display substrate, a support and a spacer may not be produced on another display substrate which is opposite to this display substrate. When a display panel is produced, a seal is applied in the preset seal area, and the two display substrates are aligned to form a cell and bonded. At this time, the supports and the spacers maintain the cell thickness and provide the supporting strength between the two substrates.

Exemplarily, when this display substrate is an array substrate 100, as shown in the lower part of FIG. 3, the array substrate 100 may comprise, in addition to the spacer 160 and the support 150, a pixel electrode 211, an insulating layer 212 located below the pixel electrode 211, a common electrode 213 located below the insulating layer 212, a data wire 214 located below the common electrode 213, a gate insulating layer 215 located below the data wire 214, a gate electrode 216 of an array transistor located below the gate insulating layer 215, and the like. When the display substrate is a color filter substrate 100′, as shown in the upper part of FIG. 3, the color filter substrate 100′ may comprise, in addition to the spacer 160 and the support 150, a black matrix 110, a color filter layer 120, a protective layer 130, an alignment layer 140, and the like. The substrate may further comprise other layers, for example a base and the like.

It is to be understood that when a display panel 200 is formed by forming a cell by aligning this display substrate and a cell alignment substrate, the display area A of the display substrate is an area where a liquid crystal layer is filled, and in order to prevent leakage of the liquid crystal layer and fixing and connecting the display substrate and the cell alignment substrate, a seal 220 is filled the preset seal area B of the display substrate and the cell alignment substrate.

As used herein, a display substrate and a cell alignment substrate refer to the display substrate of this disclosure and a substrate which is aligned with the display substrate to form a cell and bonded to it by the seal, respectively. For example, the display substrate and the cell alignment substrate may be an array substrate having a spacer and a support and a color filter substrate which is aligned with the array substrate to form a cell and bonded to the array substrate, respectively; or may be a color filter substrate having a spacer and a support and an array substrate which is aligned with the color filter substrate to form a cell and bonded to the color filter substrate, respectively.

In a conventional display panel, a plurality of spacers are provided in the display area of the display panel in order to maintain the cell thickness of the display area A, while the cell thickness and the supporting strength at the periphery of the display panel are maintained by silicon balls 230 filled in the seal 220 applied in the preset seal area B. The volume ratio of the seal 220 to the silicon balls is typically 100:1. Therefore, a conventional production process of a display panel further comprises a step of mixing the seal 220 and silicon balls in order to achieve a desired volume ratio. However, it is difficult to ensure even mixing of the silicon balls and the seal 220 in a practical mixing process, and this leads to uneven cell thickness at the periphery while the supporting strength cannot be effectively ensured, either.

In the display substrate of the structure of this Example such as the array substrate 100 or the color filter substrate 100′, a plurality of supports 150 are provided in the preset seal area B of the display substrate. This support 150 has the same effect as that of the silicon balls in the conventional seal 220, i.e., maintaining the cell thickness at the periphery and the supporting strength at the periphery of the display panel 200 formed by forming a cell by aligning this display substrate and the cell alignment substrate. At the meanwhile, the plurality of the supports 150 each comprises a supporting core 152, and this supporting cores 152 and the spacers 160 of the display area are provided in the same layer and are of the same material. Therefore, they may be formed by a patterning process in one time, so that the production process of this display substrate may be simplified and the production costs of this display substrate are in turn effectively reduced.

As used herein, “being provided in the same layer and being of the same material” refers to being formed by providing the same material on one base in the same layer forming process but the thicknesses and heights of the two which are provided in the same layer and are of the same material being possibly different. As used herein, thicknesses represent thicknesses of different components in the same layer in the vertical direction, and heights represent relative positions between different components in the same layer in the vertical direction.

It is to be further indicated that the specific number and the specific structure of the supports 150 are not limited, as long as the supports 150 provided may effectively ensure the cell thickness and the supporting strength at the periphery of the display panel 200 formed. Therefore, a desired density of the supports 150 may be obtained by preliminary calculation and analysis of the display panel 200 to be formed by the display substrate and the cell alignment substrate, and the number of the supports 150 is determined by the obtained density. For example, as for the specific structure of the supports 150, a photoresist layer may be formed on the display substrate such as the array substrate 100 or the color filter substrate 100′, and this photoresist layer may be etched with a mask plate to form desired supports 150 and spacers 160. Of course, the supports 150 may also be formed by other means, but the supports 150 provided should satisfy the requirements for the cell thickness and the supporting strength.

Optionally, a plurality of supports 150 may be evenly distributed in the preset seal area in order to allow the cell thickness at the periphery to be more even.

When a plurality of supports 150 are evenly distributed in the preset seal area in the display substrate of the structure of this Example, the cell thickness at the periphery may be further allowed to be more even in the display panel 200 formed by forming a cell by aligning the display substrate and the cell alignment substrate. The distance between two adjacent supports 150 is not limited. The distance between supports 150 and the like may be determined according to practical needs, for example the desired density of the supports 150 in the preset seal area.

Optionally, the support 150 described above has a thickness greater than that of the spacer 160.

In order to facilitate illustration, illustration is made by taking an embodiment in which this display substrate is a color filter substrate 100′ in FIG. 3 as an example. Accordingly, the cell alignment substrate is an array substrate. In the embodiment as shown in FIG. 3, when the spacer 160 located in the display area A of the color filter substrate 100′ is aligned with the array substrate to form a cell, the position of this spacer 160 corresponds to the position of a thin-film transistor on the array substrate (i.e., the position of a gate electrode 216 in the figure). One end of this spacer 160 starts from an alignment layer 140 of the color filter substrate 100′ and the other end is in contact with an alignment layer 240 on the array substrate to support the cell thickness and the strength of the display area of the display panel 200. As for the supports 150 of the preset seal area, it starts from a protective layer 130 of the color filter substrate, and the other end is in contact with an insulating layer 212 below the alignment layer 240 on the array substrate. Therefore, the thicknesses required by the spacer 160 and the support 150 may be different. The support 150 may have a thickness greater than that of the spacer 160.

Optionally, the display substrate described above is a color filter substrate 100′, and this color filter substrate comprises a black matrix 110, a color filter layer 120, and a protective layer 130. Here, this protective layer 130 covers the color filter layer 120 and the black matrix 110, and the supports 150 described above are provided on the protective layer 130.

It is to be indicated that the positional relationship between the black matrix 110 and the color filter layer 120 belongs to the general knowledge well known in the art, and verbose words are omitted herein. The gap at the lapping position between the black matrix 110 and the color filter layer 120 may be eliminated by the protective layer (over coating, OC) provided above, and the occurrence of the phenomenon of display badness may be effectively prevented. By providing the supports 150 described above on the protective layer 130, other display elements on this display substrate such as the array substrate 100 or the color filter substrate 100′ may be effectively protected while the formation of this supports 150 may also be facilitated.

In the display substrate having the structure described above, the spacer 160 and the support 150 may also be formed by a single (one-time) patterning process. Details may be referred to the third aspect of this disclosure, and verbose words are omitted herein.

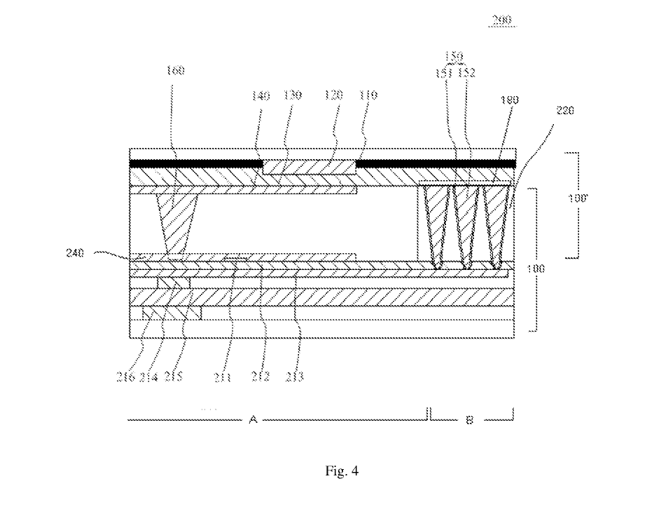

The support 150 may only comprise the supporting core 152. As shown in FIG. 4, however, the support 150 may comprise other components in addition to the supporting core 152. For example, the support 150 may further comprise a conductive layer 151 coating the supporting core 152. In this embodiment, the display substrate may further comprise a common electrode, and the conductive layer 151 is electrically connected to the common electrode. It will be easily understood that a common electrode is provided on the other display substrate which is aligned with the display substrate to form a cell, and the common electrode may be in a form of a common electrode wire in this Example. After two display substrates are aligned to form a cell, two ends of the conductive layer 151 are electrically connected to the common electrode and the common electrode wire, respectively. Therefore, the common electrode may be conducted with the common electrode wire, and common voltage signals are provided to the common electrode through the common electrode wire.

Optionally, as shown in FIG. 4, this display substrate is an array substrate 100. Accordingly, the cell alignment substrate is a color filter substrate. A common electrode wire 180 is provided on the color filter substrate, and a pixel electrode 211 and a common electrode 213 are provided on the array substrate. Upon cell alignment, the common electrode wire 180 on the color filter substrate is conducted with the common electrode 213 on the array substrate through a conductive layer 151. Conventional structures, in which the display substrate and the cell alignment substrate are electrically connected by using conductive gold beads, are replaced by the display substrate of this structure. Therefore, the production process of this display substrate may be further simplified, and the production costs are reduced.

A second aspect of this disclosure relates to a display panel 200. This display panel 200 comprises a first display substrate and a second display substrate (i.e., the cell alignment substrate described above) aligned with this first display substrate to form a cell, and this first display substrate comprises the display substrate of this disclosure. Here, this first display substrate has a preset seal area provided with a seal 220. Supports 150 are located in this seal 220 so as to bond the first display substrate to the second display substrate. The plurality of the supports 150 are in contact with the second display substrate so as to ensure the cell thickness and the surrounding supporting strength at the periphery of the display panel 200.

The display panel 200 of the structure of this Example, in which the support 150 is provided in the preset seal area of the display substrate such as an array substrate 100 or a color filter substrate 100′, may substitute for conventional means of silicon ball filling. Therefore, the production process of this display panel 200 may be simplified, and the production costs of this display panel 200 are reduced.

Optionally, as shown in FIG. 4, the first display substrate comprises a common electrode 213, and the second display substrate comprises a common electrode wire. The support comprises a supporting core 152 and a conductive layer 151 coating on the outside of the supporting core 152. The conductive layer 151 is electrically connected to each of the common electrode wire 180 and the common electrode 213 so as to allow electrical conduction of the common electrode wire 180 and the common electrode 213.

The display panel of this disclosure, in which the supports are provided in the preset seal area of the first display substrate, may substitute for conventional means of silicon ball filling. Therefore, the production process of this display panel may be simplified, and the production costs of this display panel are reduced.

A third aspect of this disclosure provides a production method for the display substrate provide above in this disclosure. As described hereinbefore, the display substrate comprises a display area and a preset seal area surrounding the display area, and this production method comprises:

forming a plurality of spacers and a plurality of supporting cores by using a single patterning process, wherein the plurality of the spacers are located in the display area of the display substrate, and the plurality of the supporting cores are located in the preset seal area of the display substrate. That is, the spacer and the supporting core are provided in the same layer and are of the same material.

Here, desired supporting cores and spacers may be form by a single patterning process. Therefore, the production process is simpler.

Optionally, the support is formed by using the supporting core.

In the production method for the display substrate of this Example, the spacer is formed in the display area of the display substrate and the support is formed in the preset seal area of the display substrate by using a single patterning process. Therefore, the structure and the production process of this display substrate may be simplified, and the production costs of the display substrate are reduced. Furthermore, in the display substrate formed by using this production method, the preset seal area of the display substrate is filled with a support instead of a conventional structure wherein silicon balls are filled to maintain the cell thickness and the supporting strength at the periphery. Therefore, the cell thickness and the surrounding supporting strength at the periphery of the display panel using this display substrate may be effectively maintained.

Optionally, the above method using a single patterning process comprises:

depositing a photoresist layer on a base substrate; and

exposing the photoresist layer with a mask plate, and developing and etching the photoresist layer to form the plurality of supports and spacers.

The production method of this Example is a specific production process for forming a plurality of supports and spacers, and the production method is simple.

Optionally, the support described above has a thickness greater than that of the spacer; a half-tone mask plate may be used as the mask plate described above; and this half-tone mask plate comprises a light-transmitting area, a semitransparent area, and a light-shielding area. When the photoresist layer deposited is a positive photoresist, this half-tone mask plate has a light-shielding area corresponding to a position where the support is required to be formed, a semitransparent area corresponding to a position where a spacer is required to be formed, and a light-transmitting area corresponding to other areas. When the photoresist layer used is a negative photoresist, the half-tone mask plate described above has a light-transmitting area corresponding to a position where the support is required to be formed, a semitransparent area corresponding to a position where a spacer is required to be formed, and a light-shielding area corresponding to other positions.

In the production method of this Example, the half-tone mask plate may be designed according to the number of and the distance between the supports required at the periphery of the display substrate, so that the desired support may be formed and the cell thickness at the periphery and the supporting strength at the periphery may be effectively ensured by exposing the photoresist layer with the designed half-tone mask plate.

In this disclosure, for example, the supporting core may be directly used as the support without any treatment. Of course, other components may also be further provided on the supporting core.

As an optional embodiment, a conductive layer coating the supporting core is formed on an outer layer of the supporting core.

In the production method of this Example, a display substrate and a cell alignment substrate aligned with this display substrate to form a cell may be conducted by forming a conductive layer on the outside of a support, wherein one end of this conductive layer is electrically connected to a common electrode or a common electrode wire preliminarily formed on the display substrate and the other end is electrically connected to a common electrode or a common electrode wire on the cell alignment substrate. For example, this display substrate may be a color filter substrate. Accordingly, a common electrode wire is formed on the color filter substrate, and a pixel electrode and a common electrode are provided on the array substrate. This conductive layer may allow electrical connection of the common electrode and the common electrode wire so as to provide a voltage difference to the pixel electrode. The display substrate formed in this Example substitutes for the conventional form of electrically conducting the display substrate and the cell alignment substrate by using conductive gold beads. The production process of the display substrate may be further simplified, and the production costs of the display substrate are reduced.

It may be understood that the above embodiments are merely exemplary embodiments used for illustrating the principle of this disclosure. However, this disclosure is not limited thereto. With respect to those of ordinary skill in the art, various variations and modifications may be made without departing from the spirit and the substance of this disclosure. These variations and modifications are also considered as the scope protected by this disclosure.

1. A display substrate, comprising
a display area, and
a preset seal area surrounding the display area,
wherein the display area is provided with a plurality of spacers, and wherein the preset seal area is provided with a plurality of supports, the support comprises a supporting core, and the supporting core and the spacer are provided in the same layer and are of the same material.

2. The display substrate according to claim 1, wherein the plurality of supports are evenly distributed in the preset seal area.

3. The display substrate according to claim 1, wherein the support has a thickness greater than that of the spacer.

4. The display substrate according to claim 1, wherein the display substrate is a color filter substrate.

5. The display substrate according to claim 4, wherein the color filter substrate comprises a color filter layer, a black matrix, and a protective layer, the protective layer covers the color filter layer and the black matrix, and the support is provided on the protective layer.

6. The display substrate according to claim 4, wherein the color filter substrate comprises a common electrode, the support further comprises a conductive layer coating the supporting core, and the conductive layer is electrically connected to the common electrode.

7. The display substrate according to claim 1, wherein the display substrate is an array substrate.

8. The display substrate according to claim 7, wherein the array substrate comprises a common electrode, the support further comprises a conductive layer coating the supporting core, and the conductive layer is electrically connected to the common electrode.

9. A display panel, comprising
the display substrate according to claim 1, and
a cell alignment substrate aligned with the display substrate to form a cell,
wherein at the preset seal area, the display substrate and the cell alignment substrate are bonded to each other by filling a seal therebetween.

10. The display panel according to claim 9, wherein at the display area, a liquid crystal is filled between the display substrate and the cell alignment substrate.

11. The display panel according to claim 9, wherein each of the display substrate and the cell alignment substrate has a common electrode, the support comprises a conductive layer coating on the outside of the supporting core, and the conductive layer allows electrical conduction between the common electrodes.

12. A production method for a display substrate, wherein the display substrate comprises a display area and a preset seal area surrounding the display area, and the production method comprises:
forming a plurality of spacers and a plurality of supporting cores by using a single patterning process, wherein the plurality of the spacers are located in the display area of the display substrate, and the plurality of the supporting cores are located in the preset seal area of the display substrate.

13. The production method according to claim 12, wherein the production method further comprises:
forming a conductive layer coating the supporting core on an outer layer of the supporting core.

14. The production method according to claim 12, wherein
the single patterning process is performed by exposing a photoresist layer with a half-tone mask plate and developing and etching the photoresist layer.

15. The production method according to claim 14, wherein
the photoresist layer is a positive photoresist layer, and the half-tone mask plate has a light-shielding area corresponding to a position where the support is to be formed, a semitransparent area corresponding to a position where the spacer is to be formed, and a light-transmitting area corresponding to other areas.

16. The production method according to claim 14, wherein
the photoresist layer is a negative photoresist layer, and the half-tone mask plate has a light-transmitting area corresponding to a position where the support is to be formed, a semitransparent area corresponding to a position where the spacer is to be formed, and a light-shielding area corresponding to other areas.
